(19) United States
(12) Patent Application Publication
(10) Pub. No.: US 2018/0371175 A1
(43) Pub. Date: Dec. 27, 2018

(54) Cationic Phototransfer Polymerization

(71) Applicants: Henkel AG & Co. KGaA, Duesseldorf (DE); Max-Planck-Gesellschaft Zur Foerderung Der ..., Muenchen (DE)

(72) Inventors: Andreas Taden, Duesseldorf (DE); Stefan Kirschbaum, Leverkusen (DE); Katharina Landfester, Mainz (DE)

(21) Appl. No.: 15/987,334

(22) Filed: May 23, 2018

Related U.S. Application Data
(63) Continuation of application No. PCT/EP2016/077537, filed on Nov. 14, 2016.

(30) Foreign Application Priority Data
Nov. 23, 2015 (EP) 15195771.9

(51) Int. Cl. C08G 81/02; C08F 216/14; C08L 75/14; C08L 67/06; C08F 2/48; C08J 7/14

(52) U.S. Cl. CPC C08G 81/024; C08F 216/1458; C08L 75/14; C08L 67/06; C08J 2367/06; C08J 7/14; C08F 2810/20; C08L 2312/00; C08J 2375/14; C08F 2/48

(57) ABSTRACT

The invention relates to a method for producing acetal-containing polymers, in particular polyurethane or polyester polymers, by reacting polymers comprising side chains of alkenyl ether groups containing monomer units derived from alkenyl ether polyols, with monofunctional or polyfunctional alcohols. The invention further relates to the polymers obtainable by the disclosed method, compositions containing said polymers, and the use thereof.

The invention relates to a method for producing acetal-containing polymers, in particular polyurethanes (PU) and polyesters, from alkenyl ether group-containing polymers and monofunctional or polyfunctional alcohols by means of cationic phototransfer polymerization. The invention further relates to the polymers obtainable by means of the method according to the invention, to compositions containing said polymers, and to the use thereof.

In organic chemistry, acetals are widely used protective groups for hydroxyl groups. One specific synthesis method is the addition reaction of vinyl ethers under anhydrous, acidic conditions. While the acetal functionality is stable under neutral or basic conditions, it is slightly hydrolyzed in aqueous, highly acidic media and the protection for the corresponding compound is thus removed. On the basis of simple chemistry, acetals have also been integrated in polymers by means of the polyaddition of divinyl ethers and dialcohols or the polyaddition of hydroxy-functionalized vinyl ethers, in order to obtain pH-controllable materials having improved degradation (Mangold et al., Macromolecules 2011, 44 (16), 6326-6334; Ruckenstein & Zhang, J. Pol. Sci. Part A: Polymer Chemistry 2000, 38, 1848-1851; Heller et al., J. Pol. Sci. Polymer Letters Edition 1980, 18, 293-297).

More complex polymer acetals have been designed using the same principles. For example, polyethers and polyphosphoesters functionalized by vinyl ether side chains in the form of pH-sensitive carrier substances for the targeted release of pharmaceutically active ingredients have been described (Mangold et al., supra; Lim et al. Macromolecules 2014, 47 (14), 4634-4644; Pohlit et al. Biomacromolecules 2015, 16, 3103-3111; Dingels & Frey, Hierarchical Macromolecular Structures: 60 Years after the Staudinger Nobel Prize II, Advances in Polymer Science, Percec, V., Ed. Springer International Publishing: 2013; Vol. 262, pp 167-190). In addition, acetal units have been incorporated into polyethers in order to provide defined splitting positions and increase degradability.

Owing to their extraordinarily electron-rich double bond, vinyl ethers are particularly well suited to this type of chemistry. For the same reasons, they are also highly reactive in cationic polymerization reactions. Under highly acidic conditions and without the presence of water, vinyl ethers can be protonated and the corresponding carbocations then react in a chain growth reaction. In terms of technical applicability, the development of onium salt-based photoacid generators by Crivello et al. (Crivello et al., Macromolecules 1977, 10 (6), 1307-1315) was a milestone. The corresponding photoinitiators can be dissolved in a monomer mixture without any prior gelation and have long storage times; when exposed to UV, however, they readily generate “super acids” as highly active species for cationic polymerization. However, cationic polymerization is sensitive to nucleophiles, hydroxyl groups for example acting as transfer agents by means of addition to the carbocation and regeneration of the proton. The rate of this transfer reaction is very fast, and, where a stoichiometric amount of alcohol is present, the literature has reported almost total acetal formation (Hashimoto et al., Journal of Polymer Science Part A: Polymer Chemistry 2002, 40 (22), 4053-4064).

The cationic polymerization of vinyl ethers, which is heavily influenced by transfer reaction, is markedly different from pure chain extension reactions. A good example of these reactions is thiol-ene addition, in which thiols are consecutively added to an unsaturated double bond and a radical transfer reaction takes place. Accordingly, a stoichiometric thiol-ene polymerization has properties more like a gradual polyaddition reaction than a radical polymerization and leads to a more uniform network structure. The polyaddition of difunctional vinyl ethers and diols exhibits similar behavior.

However, the inventors have now discovered that when sub-stoichiometric quantities of hydroxyl groups are used relative to the vinyl ether groups, cationic polymerization takes place at the same time and polymer networks that remain stable after hydrolysis are thus produced. In mechanistic terms, a polymer network forms due to interaction between cationic polymerization and polyaddition. This dual polymerization mechanism or curing reaction will be referred to hereinafter as cationic phototransfer polymerization. This polymerization delivers flexibilized products containing splittable acetal groups that can be selectively hydrolyzed to degrade part of the network structure. This improved degradability is important in terms of environmental protection and can also be used to release active ingredients in a controlled manner or to enable temporary bonds to be broken in a controlled manner.

Therefore, the present invention first relates to a method for producing an acetal-containing polymer, in particular an acetal-containing polyurethane or polyester polymer, comprising reacting at least one polymer that has alkenyl ether group side chains and contains, as a monomer unit, at least one alkenyl ether polyol containing at least one alkenyl ether group, in particular a 1-alkenyl ether group, and at least two hydroxyl groups (—OH), in particular a polyurethane or polyester, with at least one monofunctional or polyfunctional alcohol.

In another aspect, the invention relates to an acetal-containing polymer obtainable by means of the method described herein.

Another aspect of the invention relates to a method for the pH-based degradation of a polymer as described herein, the polymer being brought into contact with an aqueous solution having a pH of <7. A further aspect of the invention is a method for the pH-based release of a hydroxyl group-containing compound from a polymer as described herein, characterized in that the polymer is brought into contact with an aqueous solution having a pH of <7.

Lastly, the invention also relates to compositions, in particular adhesive compositions, sealant compositions, coating agent compositions, or cosmetic or pharmaceutical compositions, containing at least one acetal-containing polymer as described herein, and to the use of such acetal-containing polymers as components of an adhesive composition, a sealant composition, a coating agent composition, or a cosmetic or pharmaceutical composition.

### BRIEF DESCRIPTION OF THE DRAWINGS

FIG. 1 shows the storage moduli (dashed lines) and the remaining vinyl ether content (solid lines) of the curing reaction of VEPU without octanediol and with octanediol in the molar ratio of vinyl ether groups to hydroxyl groups of 1:0.5 following brief exposure to UV at 25° C.

FIG. 2 shows the rheological plots of the curing reaction of VEPU and octanediol at 70° C. and altered stoichiometry.

FIG. 3 shows the relative undecanol that could be extracted from polymer films soaked in THF as a function of duration of exposure and various additional components.

“Alkenyl ether polyol” as used herein refers to compounds that contain at least one group of formula —O-alkenyl bound to a carbon atom, and at least two hydroxyl groups (—OH). Preferably, the alkenyl ether polyol comprises an organic group, which optionally contains urethane groups and to which both the alkenyl ether group and the hydroxyl groups are bonded, i.e. the hydroxyl groups are not bonded to the alkenyl group. It is also preferable for the alkenyl ether group to be a 1-alkenyl ether group, i.e. for the C—C double bond to be adjacent to the oxygen atom. Most preferable are vinyl ether groups, i.e. groups of formula —O—CH═CH₂.

The term “urethane group” as used herein refers to groups of formula —O—C(O)—NH or —NH—C(O)—O—.

The term “alkyl” as used herein refers to a linear or branched, unsubstituted or substituted saturated hydrocarbon group, in particular groups of formula CₙH₂ₙ₊₁. Without being limited thereto, example alkyl groups include a methyl, ethyl, n-propyl isopropyl, n-butyl, 2-butyl, tert-butyl, n-pentyl, n-hexyl and the like. “Heteroalkyl” as used herein refers to alkyl groups in which at least one carbon atom is replaced by a heteroatom, such as in particular oxygen, nitrogen or sulfur. Without being limited thereto, examples include ethers and polyethers, e.g. diethylether or polyethylene oxide.

The term “alkenyl” as used herein refers to a linear or branched, unsubstituted or substituted hydrocarbon group containing at least one C—C double bond.

“Substituted”, as used here in particular in relation to alkyl and heteroalkyl groups, refers to compounds in which one or more carbon and/or hydrogen atoms are replaced by other atoms or groups. Without being limited thereto, suitable substituents include —OH, —NH₂, —NO₂, —CN, —OCN, —SCN, —NCO, —NCS, —SH, —SO₃H, —SO₂H, —COOH, —CHO and the like.

The term “organic group” as used here refers to any organic group containing carbon atoms. Organic groups can in particular be derived from carbon atoms, any carbon and hydrogen atoms being able to be replaced by other atoms or groups. Within the meaning of the invention, organic groups contain from 1 to 1000 carbon atoms in various embodiments.

“Epoxide” as used herein refers to compounds containing an epoxide group.

“Cyclic carbonate” as used herein refers to ring-shaped compounds containing the group —O—C(═O)—O— as a ring component.

The term “alcohol” refers to an organic compound containing at least one hydroxyl group (—OH).

The term “amine” refers to an organic compound comprising at least one primary or secondary amino group (—NH₂, —NHR).

The term “thiol” or “mercaptan” refers to an organic compound containing at least one thiol group (—SH).

The term “carboxylic acid” refers to a compound containing at least one carboxyl group (—C(═O)OH).

The term “derivative” as used herein refers to a chemical compound that is modified compared with a reference compound by one or more chemical reactions. In relation to the functional groups, —OH, —COOH, —SH, and —NH₂ or the compound classes of alcohols, carboxylic acids, thiols, and amines, the term “derivative” in particular covers the corresponding ionic groups/compounds and the salts thereof, i.e. alcoholates, carboxylates, thiolates, and compounds containing quaternary nitrogen atoms. In relation to the cyclic carbonates, the term “derivative” can also include the thio-derivatives of the carbonates (described in more detail below), i.e. compounds in which one, two or all three oxygen atoms of the group —O—C(═O)—O— are replaced by sulfur atoms.

“At least”, as used here in particular together with a numerical value, refers to exactly this numerical value or more. “At least one” thus signifies 1 or more, i.e. for example 2, 3, 4, 5, 6, 7, 8, 9, 10, or more. In relation to a type of compound, the term does not relate to the absolute number of molecules, but rather to the number of types of substances covered by the general term in question. For example, “at least one epoxide” thus means that at least one type of epoxide may be contained, but also that a plurality of different epoxides could be contained.

The term “curable” as used herein refers to a change in the state and/or structure in a material as a result of a chemical reaction caused usually, but not necessarily, by at least one variable, such as time, temperature, moisture, radiation, presence and amount of a curing catalyst or accelerator and the like. The term refers to both complete and partial setting of the material. “Radiation-curable” or “radiation-cross-linkable” thus refers to compounds that chemically react and form new (intramolecular or intermolecular) bonds when exposed to radiation.

“Radiation” as used herein refers to electromagnetic radiation, in particular UV light and visible light, as well as electron beams. Preferably, curing takes place by exposure to light, e.g. UV light or visible light.

The term “divalent”, as used here in connection with groups, refers to a group that has at least two linking points that form a bond to other parts of the molecule. Within the meaning of the present invention, therefore, a “divalent alkyl” thus means a group of formula -alkyl-. A divalent alkyl group of this kind is also referred to herein as an alkylenyl group. Accordingly, “polyvalent” means that a group has more than one linking point. For example, a group of this kind may be trivalent, quadrivalent, pentavalent or hexavalent. “At least divalent” thus means divalent or higher.

The term “poly” refers to a repeating unit of a (functional) group or structural unit placed after this prefix. For example, a polyol refers to a compound having at least two hydroxyl groups, and a polyalkylene glycol refers to a polymer consisting of alkylene glycol monomer units.

“Polyisocyanate” as used herein refers to organic compounds containing more than one isocyanate group (—NCO).

Unless indicated otherwise, the molecular weights indicated in this text refer to the number average of the molecular weight (Mₙ). The number-average molecular weight can be determined on the basis of a terminal group analysis (OH number according to DIN 53240; NCO content as determined by titration according to Spiegelberger in accordance with EN ISO 11909) or by means of gel permeation chromatography in accordance with DIN 55672-1:2007-08 using THF as the eluent. Unless indicated otherwise, all indicated molecular weights are those determined by means of terminal group analysis.

The alkenyl ethers can be aliphatic compounds that contain, as well as the alkenyl ether group(s), at least one other functional group that is reactive with epoxy or cyclic carbonate groups, including —OH, —COOH, —SH, —NH₂, and derivatives thereof. The functional groups attack the ring carbon of the epoxide ring or the carbonyl carbon atom of the cyclic carbonate in a nucleophilic manner, thereby opening the ring and producing a hydroxyl group. Depending on the reactive nucleophilic group, an O—C—, N—C, S—C, or O—/N—/S—C(═O)O-bond is established in the process.

The alkenyl ether polyol can be produced, for example, by means of two alternative routes A) and B).

In route A), an alkenyl ether, containing at least one alkenyl ether group and at least one functional group selected from —OH, —COOH, —SH, —NH₂, and the derivatives thereof, is reacted with (i) an epoxide or (ii) a cyclic carbonate, or a derivative thereof.

In route B), an alkenyl ether, containing at least one alkenyl ether group and at least one functional group selected from (i) epoxide groups and (ii) cyclic carbonate groups, or derivatives thereof, is reacted with an alcohol, thiol, a carboxylic acid, or an amine, or derivatives thereof. The above-mentioned alcohols, thiols, carboxylic acids, and amines can be monofunctional or polyfunctional.

Regardless of the route, the alkenyl ether polyols are produced by the hydroxyl, thiol, carboxyl, or amine groups reacting with an epoxide or cyclic carbonate and opening the ring in the process.

In all the embodiments, the reactants are selected such that the reaction product, i.e. the alkenyl ether polyol obtained, bears at least two hydroxyl groups.

For example, the alkenyl ether polyol is produced by reacting an alkenyl ether, containing at least one alkenyl ether group and at least one functional group selected from —OH, —COOH, —SH, —NH₂, and the derivatives thereof, with (i) an epoxide or (ii) a cyclic carbonate, or a derivative thereof, the alkenyl ether polyol thus produced being an alkenyl ether polyol of formula (I)

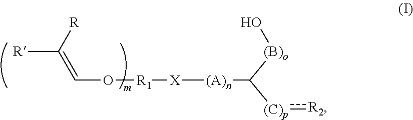

In compounds of formula (I)

R₁ is an at least divalent organic group, optionally comprising from 1 to 1000 carbon atoms, in particular an at least divalent linear or branched, substituted or unsubstituted alkyl having from 1 to 50, preferably from 1 to 20 carbon atoms, or a linear or branched, substituted or unsubstituted heteroalkyl having from 1 to 50, preferably from 1 to 20 carbon atoms, and at least one oxygen or nitrogen atom,
R₂ is an organic group, optionally comprising at least one —OH group and/or from 1 to 1000 carbon atoms, in particular an (optionally divalent or polyvalent) linear or branched, substituted or unsubstituted alkyl having from 1 to 50, preferably from 1 to 20 carbon atoms, or an (optionally divalent or polyvalent) linear or branched, substituted or unsubstituted heteroalkyl having from 1 to 50, preferably from 1 to 20 carbon atoms, and at least one oxygen or nitrogen atom. R₂ can, however, also be a group of high molecular weight, such as a polyalkylene glycol group. A (poly)alkylene glycol group of this kind can, for example, have the formula —O—[CHRₐCH₂O]_{b}—R_{b}, where Rₐ is H or a C₁₋₄ alkyl group, R_{b} is —H or an organic group, and b is from 1 to 100.

In compounds of formula (I), X is O, S, C(═O)O, OC(═O)O, C(═O)OC(═O)O, NRₓ, NRₓC(═O)O, NRₓC(═O)NRₓ or OC(═O)NRₓ. In preferred embodiments, X is O, OC(═O)O, NRₓ or NRₓC(═O)O.

Each R and R′ is selected independently from H, C₁₋₂₀ alkyl and C₂₋₂₀ alkenyl, in particular one of R and R′ being H and the other being C₁₋₄ alkyl or both R and R′ being H. Particularly preferably, R is H and R′ is H or —CH₃.

Each A, B and C is selected independently from carbon-containing groups of formula CR″R′″, R″ and R′″ being selected independently from H, a functional group, such as —OH, —NH₂, —NO₂, —CN, —OCN, —SCN, —NCO, —SCH, —SH, —SO₃H or —SO₂H, and an organic group. In particular, R″ and R′″ are independently H or C₁₋₂₀ alkyl. However, R″ and R′″ can also form an organic group, including cyclical groups, or a functional group either together or together with the carbon atom to which they are bonded. Examples of such groups are ═CH₂, ═CH-alkyl or ═C(alkyl)₂, ═O, ═S, —(CH₂)ₐₐ— where aa=3 to 5, or derivatives thereof in which one or more methylene groups are replaced by heteroatoms such as N, O or S. However, two of R″ and R′″ bonded to adjacent carbon atoms can also form a bond together. As a result, a double bond is formed between the two adjacent carbon atoms (i.e. —C(R″)═C(R″)—).

[symbol] denotes a single or double bond. Where it denotes a double bond, the carbon atom bonded to R₂ bears only one substituent R″ or R′″.

In compounds of formula (I), m is an integer from 1 to 10, preferably 1 or 2, particularly preferably 1. In other words, the compounds preferably bear just one or two alkenyl ether groups.

n, p and o are each 0 or an integer from 1 to 10. In this case, they meet the condition of n+p+o=1 or more, in particular 1 or 2. Particularly preferably, n or o is 1 and the others are 0. Alternatively, it is particularly preferable for n or o to be 2 and for the others to be 0. It is also preferable for p to be 0, one of n and o to be 1 or 2, and the other to be 0. Embodiments in which n and o are 1 and p is 0 are also preferable.

Rₓ is H, an organic group, or

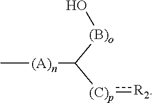

For the alkenyl ether polyol to have at least two hydroxyl groups, the compound of formula (I) also meets the condition that when Rₓ

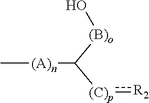

is not

R₂ comprises at least one substituent that is selected from —OH and

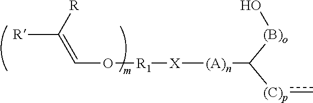

Therefore, either the second hydroxyl group of the compound of formula (I) is contained as a substituent in the organic group R₂ or X contains an additional group of formula

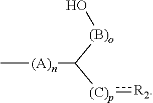

In various embodiments of the production method being described for preparing an alkenyl ether polyol, the alkenyl ether containing at least one alkenyl ether group and at least one functional group selected from —OH, —COOH, —SH—NH₂, and derivatives thereof is an alkenyl ether of formula (II).

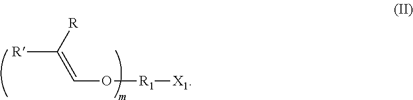

An alkenyl ether of this kind can be used, for example, to synthesize an alkenyl ether polyol of formula (I) by reacting said ether with an epoxide or a cyclic carbonate.

In compounds of formula (II), R₁, R, R′ and m are defined as above for formula (I). In particular, the preferred embodiments of R₁, R, R′ and m described for the compounds of formula (I) can likewise be transferred to the compounds of formula (II).

In compounds of formula (II)

X₁ is a functional group selected from —OH, —COOH, —SH, —NHR_{y} and derivatives thereof, and R_{y} is H or an organic group, preferably H.

The derivatives of the functional groups —OH, —COOH, —SH and —NHR_{y} are preferably the ionic variants that are described above in connection with the definition of the term and produced by removing or bonding a proton, in particular the alcoholates, thiolates and carboxylates thereof, most preferably the alcoholates.

Particularly preferably, X₁ is —OH or —O or —NH₂.

One embodiment of the method being described for producing the alkenyl ether polyols is also characterized in that, in the alkenyl ethers of formula (II), m is 1, X₁ is —OH or NH₂, preferably —OH, R₁ is a divalent, linear or branched C₁₋₁₀ alkyl group (alkylenyl group), in particular ethylenyl, propylenyl, butylenyl, pentylenyl or hexylenyl, and one of R and R′ is H and the other is H or —CH₃.

The alkenyl ethers that can be used as part of the method being described for producing the alkenyl ether polyols, in particular those of formula (II), can for example be products of reactions of various optionally substituted alkanols (monoalcohols and polyols) with acetylene. Without being limited thereto, specific examples include 4-hydroxybutyl vinyl ether (HBVE) and 3-aminopropyl vinyl ether (APVE).

Another embodiment of the method being described for producing the alkenyl ether polyols is characterized in that the epoxide reacted with the alkenyl ether is an epoxide of formula (III) or (IIIa)

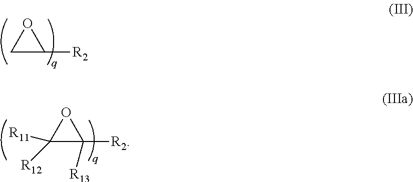

In compounds of formula (III) and (IIIa), R₂ is defined as above for formula (I).

R₁₁, R₁₂ and R₁₃ are, independently of one another, H or an organic group, optionally having at least one —OH group, in particular a linear or branched, substituted or unsubstituted alkyl having from 1 to 20 carbon atoms, or a linear or branched, substituted or unsubstituted heteroalkyl having from 1 to 20 carbon atoms and at least one oxygen or nitrogen atom.

q is an integer from 1 to 10, preferably 1 or 2.

Accordingly, epoxy compounds that can be used in the methods for producing alkenyl ether polyols are preferably linear or branched, substituted or unsubstituted alkanes that have from 1 to 1000 carbon atoms, preferably from 1 to 50 or from 1 to 20, and bear at least one epoxy group. Optionally, these epoxy compounds can additionally also bear one or more hydroxyl groups, as a result of which the hydroxy functionalization level of the alkenyl ether polyol produced from reacting an alkenyl ether that is reactive with epoxides with an epoxide, as described above, is high. In turn, the cross-linking density of the desired polymer can thus be monitored and controlled in subsequent polymerization reactions.

When reacting an alkenyl ether compound that is reactive with epoxides (alkenyl ether comprising at least one functional group selected from —OH, —COOH, —SH, —NH₂ and derivatives thereof), an alcohol is produced, and the epoxide ring opened in the process. As a result of the reactions of a first alcohol, or a chemically related compound in this context (amine, thiol, carboxylic acid, etc.), with an epoxide, the alcohol group is thus “regenerated” when the bond is formed.

In various embodiments, the epoxy compound can bear more than one epoxy group. This makes it possible to react an epoxy compound of this kind with more than one alkenyl ether compound that is reactive with epoxides, for example an aminoalkenyl ether or hydroxyalkenyl ether.

In particularly preferred embodiments, the epoxide is an epoxide of formula (III), where q is 1 or 2 and, when q is 2, R₂ is —CH₂—O—C₁₋₁₀-alkylenyl-O—CH₂—, and, when q is 1, R₂ is —CH₂—O—C₁₋₁₀-alkyl.

Example epoxy compounds that can be used in the method for producing alkenyl ether polyols are in particular glycidyl ethers, e.g. 1,4-butanediol diglycidyl ether (BDDGE), polyalkylene glycol diglycidyl ether, trimethylolpropane triglycidyl ether, bisphenol-A diglycidyl ether (BADGE), Novolak-based epoxides and epoxidized polybutadienes or fatty acid esters.

In various embodiments, the alkenyl ether polyol of formula (I) can be prepared by reacting an alkenyl ether of formula (II) with an epoxide of formula (III) or (IIIa).

Instead of an epoxide, the compounds that are reacted with the compounds that are reactive with epoxides (alkenyl ether compounds) can also be cyclic carbonates or the derivatives thereof. Cyclic carbonate compounds are similar to the epoxides in terms of their reactivity to the compounds that are used as reactants and which add both epoxides and cyclic carbonates to the methylene of the epoxide ring, in the case of an epoxide, or to the carbonyl carbon atom, in the case of a cyclic carbonate, in a nucleophilic manner while opening the ring and “regenerating” an alcohol functional group, as a result of which an O—C—, N—C, S—C, or O—/N—/S—C(═O)O bond is formed, depending on the reactive nucleophilic group.

In preferred embodiments, the cyclic carbonates that, in the method being described for producing the alkenyl ether polyols, can be reacted with an alkenyl ether, in particular an alkenyl ether of formula (II), are cyclic carbonates of formula (IV) or (IVa)

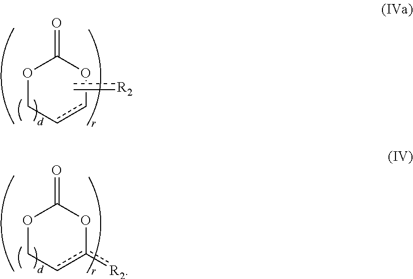

In compounds of formula (IV) and (IVa), R₂ is defined as above for formulae (I), (III) and (IIIa). In particular, R₂ is a C₁₋₁₀ hydroxyalkyl. In other embodiments, R₂ can be ═CH₂.

[symbol] is a single or double bond, preferably a single bond. It goes without saying that, when the ring contains a double bond, R₂ is not bonded by means of an exo-double bond but rather by a single bond, and vice versa.

d is 0, 1, 2, 3, 4 or 5, preferably 0 or 1, particularly preferably 0, and r is an integer from 1 to 10, preferably 1 or 2, most preferably 1.

When d is 1, i.e. the cyclic carbonate is a 1,3-dioxane-2-one, R₂ can be in position 4 or 5, but is preferably in position 5.

Without being limited thereto, example cyclic carbonates include 1,3-dioxolane-2-one, 4,5-dehydro-1,3-dioxolane-2-one, 4-methylene-1,3-dioxolane-2-one and 1,3-dioxane-2-one, substituted by R₂ in position 4 or 5.

In various embodiments of the methods being described for producing the alkenyl ether polyols, cyclic carbonates that are derivatives of the carbonates of formulae (IV) and (IVa) are used. Example derivatives include those that are substituted on the ring methylene groups, in particular on those that do not bear the R₂ group, by organic groups for example, in particular linear or branched, substituted or unsubstituted alkyl or alkenyl groups having up to 20 carbon atoms, in particular ═CH₂ and —CH═CH₂, or linear or branched, substituted or unsubstituted heteroalkyl groups or heteroalkenyl groups having up to 20 carbon atoms and at least one oxygen or nitrogen atom, or functional groups such as —OH or —COOH. Examples of such derivatives include 4-methylene-1,3-dioxolane-2-one, which bears the R₂ group at position 5, or di-(trimethylolpropane)dicarbonate, in which the R₂ group in position 5 is a methylene trimethylol monocarbonate group.

In various embodiments in which the R₂ group is bonded by means of a single bond, the ring carbon atom borne by the R₂ group can be substituted by another substituent defined as with the aforementioned substituents or the other ring methylene group.

Other derivatives are those in which one or both of the ring oxygen atoms are replaced by sulfur atoms, and those in which the carbonyl oxygen atom is alternatively or additionally replaced by a sulfur atom. A particularly preferable derivative is 1,3-oxathiolane-2-thione.

In various embodiments, the cyclic carbonate is 4-methylene-1,3-dioxolane-2-one, which bears the R₂ group at position 5. If a cyclic carbonate of this kind is reacted with an alkenyl ether that bears an amino group as a reactive group, a compound of formula (Ia) can be formed:

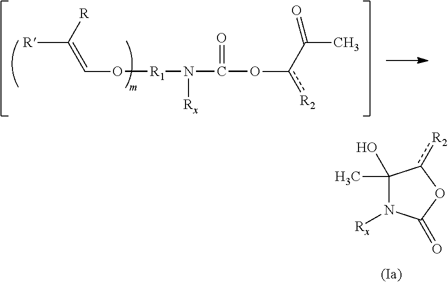

In this compound, m, R₁, R, R′, R₂ and Rₓ are defined as above for the compounds of formulae (I)-(IV). The compounds of formula (Ia) do not contain an alkenyl ether group and can therefore be used as polyols for producing polyurethanes or polyesters, although only when combined with other polyols that contain alkenyl ether groups. Compounds of this kind of formula (Ia) are therefore not preferable according to the invention.

When reacting the above-described cyclic carbonates and the derivatives thereof of formula (IV) and (IVa) with a compound of formula (II), in various embodiments in compounds of formula (II), (i) X₁ is —NH₂ or a derivative thereof, and in the compound of formula (IV) or (IVa), r is 1; or (ii) X₁ is —OH or a derivative thereof, and in the compound of formula (IV) or (IVa), r is 2.

In various embodiments of the invention, alkenyl ether polyols that contain at least one urethane group are preferred. These can be prepared by reacting the aforementioned alkenyl ethers, which bear an amino group as a reactive group, with the above-described cyclic carbonates.

In various embodiments, the alkenyl ether polyol can be prepared by reacting the compounds listed in route B). In this case, the alkenyl ether polyol is produced by reacting an alkenyl ether, containing at least one alkenyl ether group and at least one functional group selected from (i) epoxide groups and (ii) cyclic carbonate groups, or derivatives thereof, with an alcohol, thiol, a carboxylic acid, or an amine, or derivatives thereof.

In various embodiments of this method, the alkenyl ether polyol is an alkenyl ether polyol of formula (V)

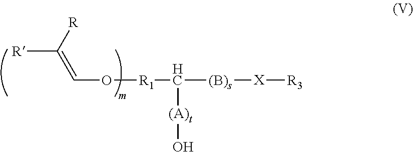

In compounds of formula (V), R₁ is defined as above for compounds of formula (I).

R₃ is an organic group, optionally comprising at least one —OH group and/or from 1 to 1000 carbon atoms, in particular an (optionally divalent or polyvalent) linear or branched, substituted or unsubstituted alkyl having from 1 to 50, preferably from 1 to 20 carbon atoms, or an (optionally divalent or polyvalent) linear or branched, substituted or unsubstituted heteroalkyl having from 1 to 50, preferably from 1 to 20 carbon atoms, and at least one oxygen or nitrogen atom. R₂ can, however, also be a group of high molecular weight, such as a polyalkylene glycol group. A (poly)alkenyl glycol group of this kind can, for example, have the formula —O—[CHRₐCH₂O]_{b}—R_{b}, where Rₐ is H or a C₁₋₄ alkyl group, R_{b} is —H, an organic group or

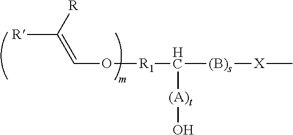

and b is from 1 to 100.

In compounds of formula (V), X is O, S, OC(═O), OC(═O)O, OC(═O)OC(═O), NR_{z}, NR_{z}C(═O)O, NR_{z}C(═O)NR_{z} or OC(═O)NR_{z}. In preferred embodiments, X is O, OC(═O)O, NR_{z} or OC(═O)NR_{z}.

Each R and R′ is selected independently from H, C₁₋₂₀ alkyl and C₂₋₂₀ alkenyl, in particular one of R and R′ being H and the other being C₁₋₄ alkyl or both R and R′ being H. Particularly preferably, R is H and R′ is H or —CH₃.

Each A and B is selected independently from CR″R′″, R″ and R′″ being selected independently from H, a functional group, such as —OH, —NH₂, —NO₂, —CN, —OCN, —SCN, —NCO, —NCS, —SH, —SO₃H or —SO₂H, and an organic group. In particular, R″ and R′″ are independently H or C₁₋₂₀ alkyl. However, R″ and R′″ can also form an organic group, including cyclical groups, or a functional group either together or together with the carbon atom to which they are bonded. Examples of such groups are ═CH₂, ═CH-alkyl or ═C(alkyl)₂, ═O, ═S, —(CH₂)ₐₐ— where aa=3 to 5, or derivatives thereof in which one or more methylene groups are replaced by heteroatoms such as N, O or S. However, two of R″ and R′″ bonded to adjacent carbon atoms can also form a bond together. As a result, a double bond is formed between the two adjacent carbon atoms (i.e. —C(R″)═C(R″)—).

In compounds of formula (V), m is an integer from 1 to 10, preferably 1 or 2, particularly preferably 1. In other words, the compounds preferably bear just one or two alkenyl ether groups.

s and t are each 0 or an integer from 1 to 10. In this case, they meet the condition of s+t=1 or more, in particular 1 or 2. Particularly preferably, s or t is 1 and the other is 0.

R_{z} is H, an organic group, or

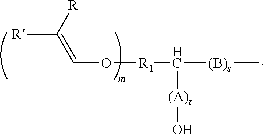

For the alkenyl ether polyol of formula (V) to meet the condition of bearing at least two hydroxyl groups, if R_{z} is not

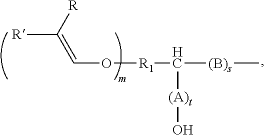

R₃ is substituted by at least one substituent that is selected from —OH and

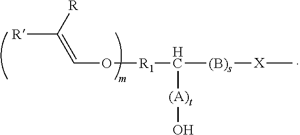

In other preferred embodiments, the method is characterized in that the alkenyl ether, containing at least one alkenyl ether group and at least one functional group selected from (i) epoxide groups and (ii) cyclic carbonate groups or derivatives thereof, is an alkenyl ether of formula (VI) or (VII)

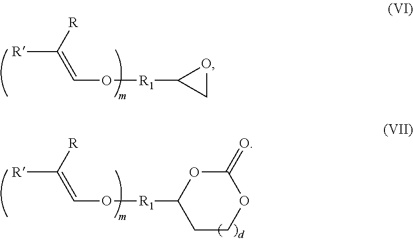

In compounds of formula (VI) or (VII), R₁, R, R′ and m are defined as above for compounds of formulae (I) and (II).

d is defined as above for formulae (IV) and (IVa), i.e. d is 0, 1, 2, 3, 4 or 5, preferably 0 or 1, particularly preferably 0.

In particularly preferred embodiments, R₁ is —C₁₋₁₀-alkylenyl-O—CH₂— in the alkenyl ethers of formula (VI) or (VII).

The alkenyl ethers of formula (VI) bearing epoxy groups can be substituted at the epoxy group, i.e. the methylene groups of the oxirane ring can be substituted with R₁₁-R₁₃, as in formula (IIIa).

In various embodiments, the alkenyl ethers of formula (VII) are substituted at the cyclic carbonate ring or the cyclic carbonate ring is replaced by a corresponding derivative. Suitable substituted cyclic carbonates and derivatives thereof are those that were described above in relation to formulae (IV) and (IVa). In particular, the cyclic carbonate group is preferably a 1,3-dioxolane-2-one group or a 1,3-dioxane-2-one group that can optionally be substituted, for example by a methylene group.

Without being limited thereto, suitable compounds of formula (VI) include vinyl glycidyl ethers and 4-glycidyl butyl vinyl ethers (GBVE), GBVE being able to be prepared by reacting 4-hydroxybutyl vinyl ether with epichlorohydrin.

Without being limited thereto, suitable compounds of formula (VII) include 4-(ethenyloxymethyl)-1,3-dioxolane-2-one, which can be prepared for example by the interesterification of glycerol carbonate with ethyl vinyl ester, or 4-glycerol carbonate butyl vinyl ether (GCBVE), which can be prepared by epoxidizing hydroxybutyl vinyl ether (HBVE) followed by CO₂ insertion.

In various embodiments, the alkenyl ether, containing at least one alkenyl ether group and at least one functional group selected from (i) epoxide groups and (ii) cyclic carbonate groups, or derivatives thereof, in particular one of formula (VI) or (VII), is reacted with an alcohol or an amine. The alcohol can be a diol or polyol or a corresponding alcoholate. In particular, the alcohol can be a polyalkylene glycol of formula HO—[CHRₐCH₂O]_{b}—H, where Rₐ is H or a C₁₋₄ alkyl group and b is from 1 to 100, in particular from 1 to 10.

Route B) is therefore an alternative embodiment in which the epoxide or cyclic carbonate compounds (e.g. ethylene carbonate compounds or trimethyl carbonate compounds) comprise at least one or more alkenyl ether groups. The desired alkenyl ether polyols are produced by reacting said epoxide or cyclic carbonate compounds with compounds that are reactive with epoxides or with compounds whose reactivity is chemically similar within the context of this invention (cyclic carbonates), in particular those bearing —OH, —COOH, —SH, —NH₂ groups and the like, or derivatives thereof, for example linear or branched, saturated or partially unsaturated, additionally substituted or unsubstituted, cyclic or linear (hetero)alkyls and (hetero)aryls that have been functionalized accordingly, preferably functionalized accordingly multiple times.

Without being limited thereto, example compounds that comprise at least one of the groups —OH, —COOH, —SH, —NH₂, and the derivative forms thereof, but no alkenyl ether groups, are glycols, polyglycols, amino acids, polyols and diamines and polyamines, e.g. glycine, glycerol, hexamethylenediamine, 1,4-butanediol and 1,6-hexanediol.

In various embodiments, alkenyl ether polyols that have at least one urethane group and can be prepared by reacting an alkenyl ether with cyclic carbonate groups and an amine, are preferred.

The alkenyl ether polyols that can be produced or obtained by means of the methods being described are, for example, compounds of formulae (I), (Ia) and (V), as defined above.

In various embodiments of the alkenyl ether polyols of formula (I):
(1) m=1; both R and R′ are H, or R is H and R′ is methyl; R₁ is C₁₋₁₀ alkylenyl, in particular C₁₋₆ alkylenyl, X is O, A and B are CH₂, n and o are 1 or 0, and p is 0, where n+o=1, and R₂ is an organic group that either is substituted with —OH or bears another group of formula

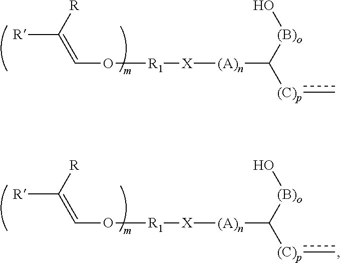

where R₁, m, R, R′, A, B, C, n, o, and p are defined as above; or
(2) m=1; both R and R′ are H, or R is H and R′ is methyl; R₁ is C₁₋₁₀ alkylenyl, in particular C₁₋₆ alkylenyl, X is NRₓ, A and B are CH₂, n and o are 1 or 0, and p is 0, where n+o=1, Rₓ is H or

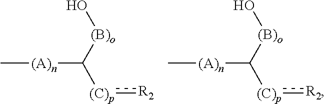

where A, B, C, n, o and p are defined as above; and R₂ is an organic group as defined above that, when Rₓ is H, either is substituted with —OH or bears another group of formula

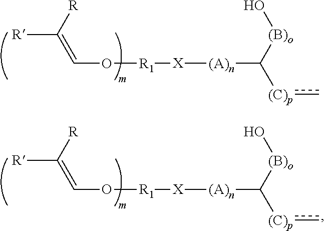

where R₁, m, R, R′, A, B, C, n, o, and p are defined as above; or
(3) m=1; both R and R′ are H, or R is H and R′ is methyl; R₁ is C₁₋₁₀ alkylenyl, in particular C₁₋₆ alkylenyl, X is OC(═O)O, A and B are CH₂, n and o are 1 or 0, and p is 0, where n+o=1, and R₂ is an organic group that either is substituted with —OH or bears another group of formula

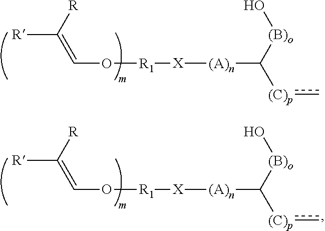

where R₁, m, R, R′, A, B, C, n, o, and p are defined as above; or
(4) m=1; both R and R′ are H, or R is H and R′ is methyl; R₁ is C₁₋₁₀ alkylenyl, in particular C₁₋₆ alkylenyl, X is NRₓC(═O)O, A and B are CH₂, n and o are 1 or 0, and p is 0, where n+o=1, Rₓ is H or

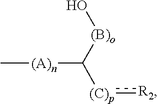

where A, B, C, n, o and p are defined as above; and R₂ is an organic group as defined above that, when Rₓ is H, either is substituted with —OH or bears another group of formula

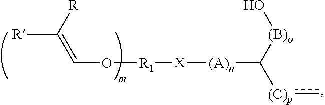

where R₁, m, R, R′, A, B, C, n, o, and p are defined as above.

In the above embodiments, R₂ is preferably bonded by means of a single bond and can, for example, be a heteroalkyl group, in particular an alkyl ether group having from 2 to 10 carbon atoms. Suitable groups are, for example, those of formula —CH₂—O—(CH₂)₄—O—CH₂ (if R₂ bears two alkenyl ether groups of the above formula) or —CH₂—O—CH(CH₃)₂.

In various embodiments of the alkenyl ether polyols of formula (V):
(1) m=1; both R and R′ are H, or R is H and R′ is methyl; R₁ is —(CH₂)₁₋₁₀—O—CH₂—, in particular —(CH₂)₁₋₆—O—CH₂—, X is O, A and B are CH₂, s and t are 1 or 0, where s+t=1, and R₃ is an organic group that either is substituted with —OH or bears another group of formula

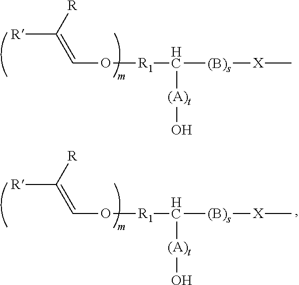

where R₁, m, R, R′, A, B, s and t are defined as above; or
(2) m=1; both R and R′ are H, or R is H and R′ is methyl; R₁ is —(CH₂)₁₋₁₀—O—CH₂—, in particular —(CH₂)₁₋₆—O—CH₂—, X is NR_{z}, A and B are CH₂, s and t are 1 or 0, where s+t=1, R_{z} is H or

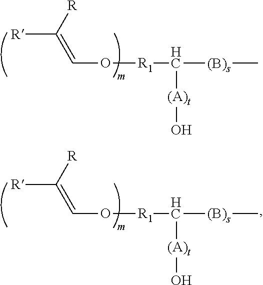

where A, B, m, s and t are defined as above; and R₃ is an organic group as defined above that, when R_{z} is H, either is substituted with —OH or bears another group of formula

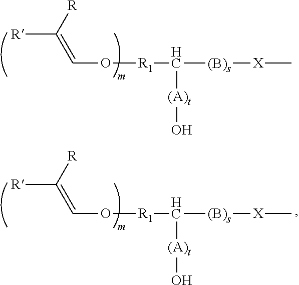

where R₁, m, R, R′, A, B, s and t are defined as above; or
(3) m=1; both R and R′ are H, or R is H and R′ is methyl; R₁ is —(CH₂)₁₋₁₀—O—CH₂—, in particular —(CH₂)₁₋₆—O—CH₂—, X is OC(═O)O, A and B are CH₂, s and t are 1 or 0, where s+t=1, and R₃ is an organic group that either is substituted with —OH or bears another group of formula

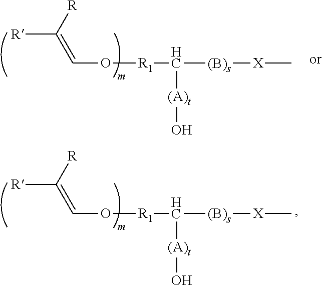

where R₁, m, R, R′, A, B, s and t are defined as above;
(4) m=1; both R and R′ are H, or R is H and R′ is methyl; R₁ is —(CH₂)₁₋₁₀—O—CH₂—, in particular —(CH₂)₁₋₆—O—CH₂—, X is OC(═O)NR_{z}, A and B are CH₂, s and t are 1 or 0, where s+t=1, R_{z} is H or

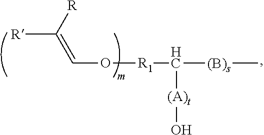

where A, B, m, s and t are defined as above; and R₃ is an organic group as defined above that, when R_{z} is H, either is substituted with —OH or bears another group of formula

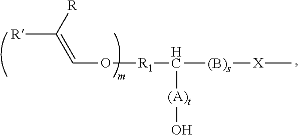

where R₁, m, R, R′, A, B, s and t are defined as above.

In the above embodiments of compounds of formula (V), R₃ is, for example, a heteroalkyl group, in particular a (poly)alkylene glycol, such as in particular polypropylene glycol, or a C₁₋₁₀ alkyl or alkylenyl group.

The individual steps of the method being described for producing the alkenyl ether polyols of formula (I) or (V) can be carried out according to conventional methods for such reactions. For this purpose, the reactants can be brought into contact with one another, optionally after activation (for example producing alcoholates by reaction with sodium) and optionally reacted in an inert, temperature-controlled atmosphere.

The aforementioned alkenyl ether polyols are then used to synthesize polymers, in particular polyurethanes or polyesters, by being reacted with polyisocyanates or polycarboxylic acids or polycarboxylic acid derivatives, such as esters thereof, in particular alkyl esters. Depending on which component is used in excess, it is possible to obtain OH-terminated or —NCO-terminated polyurethanes having alkenyl ether side chains or OH-terminated or COOR-terminated polyesters, where R═H or alkyl, having alkenyl ether side chains. During the synthesis, the alkenyl ether polyols can also be used in combination with other, non-alkenyl-ether-functionalized polyols. The functionality of the obtained polymers can be controlled by means of the amounts used. The polymers thus obtained preferably have an alkenyl ether functionality in the range of from 1 to 1000, preferably from 1 to 20. The NCO-terminated or COOR-terminated polymers are preferably terminal-blocked by monofunctional alcohols containing vinyl ether groups. Alternatively, OH-terminated polymers can be terminal-blocked by monofunctional isocyanates containing vinyl ether groups.

To obtain acetal-containing polymers, said polymers having alkenyl ether side chains are then reacted with a monofunctional or polyfunctional alcohol under highly acidic conditions and without the presence of water, the hydroxyl group(s) of the alcohol reacting with the alkenyl ether groups of the polymer in a transfer reaction and forming acetals. If the reaction is carried out using a stoichiometric shortage of alcohol, cationic polymerization of the alkenyl ether groups, which can be initiated by exposure to radiation and by suitable photoinitiators, takes place concurrently with the addition reaction. As mentioned above, this dual cross-linking mechanism is referred to herein as “cationic phototransfer polymerization”. Whereas sub-stoichiometry is preferred in order to force the formation of polyvinyl ethers, it has been discovered that said ethers can be formed even before the alcohol has reacted off, and so even a moderate excess of alcohol still leads to only partially degradable materials.

Whereas the molar ratio of alkenyl ether groups to hydroxyl groups can be in the range of from 0.01 to 100, preferably from 0.1 to 10.0, more preferably from 0.2 to 5.0, even more preferably from 0.8 to 4.0, even more preferably from 1.0 to 2.0, in various embodiments of the invention the reaction is carried out in the presence of sub-stoichiometric amounts of alcohol relative to the alkenyl ether groups. In this regard, “sub-stoichiometric” denotes a molar ratio of alkenyl ether groups to hydroxyl groups of more than 1, in particular from 1.1 to 10, preferably from 1.2 to 3.0, more preferably from 1.3-2.0. As already mentioned above, however, slight excesses of hydroxyl groups can also lead to dual cross-linking. In various embodiments, therefore, molar ratios of alkenyl ether groups to hydroxyl groups of at least 0.8, preferably at least 0.9, more preferably of 0.95, are preferred, the upper limit possibly being, for example, 10, preferably 3.0, more preferably 2.0, most preferably 1.5.

In various embodiments, acidic or highly acidic and anhydrous conditions are used as the reaction conditions. To enable concurrent cationic polymerization, the reaction can preferably take place in the presence of one or more suitable photoinitiators and with exposure to radiation, in particular exposure to light or UV.

The polymers thus obtained are cross-linked with one another by means of the polymerization of the alkenyl ether groups, and also contain acetals, the polyfunctional alcohols used to form the acetals also causing the polymers to cross-link. Whereas the acetals formed are acid-labile and are hydrolyzed in the presence of water and at low pHs, the polymerized alkenyl ether groups are stable in acid. As a result, the polymers only degrade partially and thus the mechanical and rheological properties can be modulated, such as releasing the hydroxyl compounds bonded by means of the acetals.

In this case, the alcohols used are compounds comprising at least one hydroxyl group.

Monofunctional alcohols produce acetal-containing polymers that contain the alcohol groups as side chains. In various embodiments, these monofunctional alcohols are compounds that comprise a hydroxyl group and optionally have an additional function, e.g. as pharmaceutically active ingredients. These compounds, which are bonded to the polymer backbone while forming acetals, can then be released in a pH-controlled manner by means of hydrolysis, e.g. in aqueous solutions. Accordingly, the acetal-containing polymers described herein can be used as controlled-release agents, the compound to be released being the monofunctional alcohol. The type of compounds bonded in this manner is unlimited, provided that they comprise at least one hydroxyl group and cannot otherwise interact with the polymer backbone in an undesired manner.

Difunctional alcohols and above also produce acetal-containing polymers, which are then reversibly cross-linked by means of the alcohol groups. The degree of cross-linking in the polymers can then be controlled by means of the functionality of the alcohols. Since this cross-linking is also reversible and the polyfunctional alcohols can be released by hydrolysis, the mechanical and rheological properties of the polymers can also be controlled by controlling the cross-linking. In addition, and as with the use of monofunctional alcohols, controlled release of the higher-function alcohols is also conceivable. This means that, in various embodiments, the higher-function alcohols can also have an additional function that goes beyond that of the simple cross-linking function, e.g. an active ingredient function.

In various embodiments of the invention, the monofunctional or polyfunctional alcohol is a compound of formula (VI)

R₄(OH)ᵤ (VI)

where R₄ is a monovalent or polyvalent organic group, in particular a monovalent or divalent linear or branched, substituted or unsubstituted alkyl having from 1 to 20 carbon atoms, or a linear or branched, substituted or unsubstituted heteroalkyl having from 1 to 20 carbon atoms and at least one oxygen or nitrogen atom; and u is an integer from 1 to 10, preferably from 1 to 4.

The group R₄ is an alkyl group or heteroalkyl group in particular when it is used primarily to control branching and thus the polymer properties. In other embodiments, as described above, in which the compound bonded by means of the acetals has an additional function, e.g. as a pharmaceutical or cosmetic active ingredient, the group R₄ is accordingly an appropriate active ingredient group. Since there are in principle an enormous number of options for such active ingredient coupling, in view of the fact that there are no other restrictions apart from the necessary hydroxyl groups and the compatibility with the polymer, the active ingredient is not restricted to a particular active ingredient or a particular group of active ingredients. In addition to the aforementioned cosmetic and pharmaceutical active ingredients, any other active ingredients having other functions can also be used.

In various embodiments, the monofunctional or polyfunctional alcohol can be a hydroxyl group-containing polymer, in particular a polyvinyl alcohol, preferably having a functionality from 1 to 1000.

The highly acidic conditions are preferably produced by the use of suitable acids or super acids.

In general, all photoinitiators known in the prior art are suitable for the radiation-dependent curing reaction. Optionally, these can also be used in combination with known sensitizers. An overview of suitable initiators, in particular iodonium-based and sulfonium-based compounds, especially those comprising anions, selected from hexafluorophosphates (PF₆⁻), tetrafluoroborate (BF₄⁻) and hexafluoroantimonate (SbF₆⁻) can be found, for example, in Sangermano et al. (Macromol. Mater. Eng. 2014, 299, 775-793).

Photoinitiators of this kind enable the simultaneous cationic polymerization of the alkenyl/vinyl groups and the acetal formation as a result of the addition reaction of the alcohols.

In various embodiments of the method according to the invention, the reactants, i.e. the alkenyl ether group-containing polymers and the alcohols, are made to react by exposure to electromagnetic radiation in the presence of a photoinitiator, e.g. 4,4′-dimethyldiphenyliodoniumhexafluorophosphate (Omnicat 440, IGM). The reaction mechanism is a cationic polymerization of the alkenyl groups and addition of the alcohols, it also being possible to regard said addition as a cross-linking polyaddition when the functionality is 2 or more. The reaction can take place in solution in a suitable organic solvent, e.g. THF, since this can make the reaction simpler to control. The electromagnetic radiation can in particular be visible light or UV light, and is selected on the basis of the photoinitiators used.

Once the reaction is complete, the remaining acids can be neutralized. For this purpose, all neutralization agents suitable for this purpose for a person skilled in the art can be used. Additionally or alternatively, suitable buffers can be used to stabilize or buffer the systems obtained against degradation due to acids residues.

Lastly, the invention also relates to the acetal-containing polymers that can be produced by means of the methods being described herein. Depending on the type and amount of alcohols used, in particular when using polyvalent alcohols and sub-stoichiometric volumes of the alcohols, said polymers can be cross-linked polymers. The polymers can also be provided in the form of water-based dispersions, in particular polyurethane dispersions (PUD), it being necessary to control the pH of these dispersions such that the acetals are not (prematurely) hydrolyzed.

The polymers thus obtained comprise acetals that can be hydrolyzed under suitable conditions. For example, aqueous solutions having pHs of less than 7, preferably of 5 or less, more preferably of 4 or less, most preferably of 3 or less, are suitable for this purpose. In general, the presence of an acid is required, preferably a sufficiently strong acid having a pKₛ value of <4 under standard conditions (25° C., 1013 mbar). In one aspect, therefore, the invention also relates to methods for the pH-based degradation of a polymer as described herein, the acetals of the polymer being hydrolyzed under suitable conditions, for example by being brought into contact with an aqueous solution having a pH of <7. In this context, “degradation” thus means the hydrolysis of previously formed bonds and thus a reversal of the cross-linking reaction, provided this has taken place by means of acetal formation. In the same way, the alcohols can be released again by hydrolyzing the acetals under suitable conditions. As described above, this is particularly beneficial if the alcohols are active ingredients that bear hydroxyl groups and have additional functions. Therefore, the invention also relates to methods for the pH-based release of a hydroxyl group-containing compound from a polymer as described herein, the acetals of the polymer being hydrolyzed under suitable conditions, for example by being brought into contact with an aqueous solution having a pH of <7.

Furthermore, the invention also covers compositions containing the polymers described herein, in particular adhesives, sealants, coating agents, 3D printing compositions, or lithography, cosmetic or pharmaceutical compositions.

The invention also relates to the use of the polymers described herein as a component of adhesives, sealants, coating agents, cosmetic or pharmaceutical compositions, and in 3D printing and lithography applications. Compositions of this kind can also contain all common additives and auxiliary agents known to a person skilled in the art.

All the embodiments disclosed herein in relation to the methods according to the invention for producing the polymers can also be transferred to the above-described polymers per se, as well to their use and the methods for their production, and vice versa.

The invention will be illustrated in more detail below on the basis of examples, although these should not be taken as limiting.

### EXAMPLES

Materials Used:

4-hydroxybutyl vinyl ether (HBVE) (BASF, 99% stabilized with 0.01% KOH) was stored above a 4 Å molecular sieve. Sodium (Merck, 99%) was stored in paraffin oil and the oxidized surface removed. 1,4-butanediol diglycidyl ether (BDDGE, Sigma-Aldrich, 95%), isophorone diisocyanate (IPDI, Merck, 99%), dimethyl zinc dineodecanoate (Momentive, Fomrez catalyst UL-28), octanediol (Acros Organics, 98%), undecanol (Acros Organics, 98%) and 4,4′-dimethyl diphenyliodonium hexafluorophosphate (Omnicat 440, IGM, 98%) were used as received.

### Example 1: Synthesis of the Vinyl Ether Polyol

139.51 g (1.2 mol) HBVE was placed in a 250 ml round-bottom flask. A dropping funnel having a pressure compensator was connected and 24.78 g (0.12 mol) BDDGE was placed therein. The apparatus as a whole was dried in a vacuum and flooded with nitrogen. 7.00 g (0.3 mol) sodium was added. Once the sodium was completely dissolved, BDDGE was slowly added. The temperature was controlled such as to remain below 50° C. Once all the BDDGE was added, the mixture was stirred at 50° C. for a period of 30 min. 50 ml water was added to hydrolyze the remaining alcoholate. The product was washed multiple times using saturated sodium chloride solution and water and then concentrated in a vacuum in order to remove any reactant or water residues. Yield: 76%. ¹H-NMR (CDCl₃), xy MHz): δ (pp)=1.6-1.8 (12H, mid-CH₂ butyl), 2.69 (2H, OH, H/D interchangeable), 3.4-3.55 (16H, CH₂—O—CH₂), 3.70 (4H, CH₂—O-vinyl), 3.94 (2H, CH—O), 3.98 (1H, CH₂═CH—O trans), 4.17 (1H, CH₂═CH—O cis), 6.46 (1H, CH₂═CH—O gemi).

### Example 2: Synthesis of Vinyl-Ether-Functionalized Polyurethane (VEPU)

40.00 g (92 mmol) of the vinyl ether polyol synthesized in Example 1 was placed in a 250 ml flask, degassed at 75° C. at reduced pressure, and flushed with nitrogen. At 15° C., 23.28 g (105 mmol) isophorone diisocyanate and 0.0127 g dimethyl zinc dineodecanoate were added and the mixture slowly heated to 80° C. After a reaction time of 1 hour, 2.651 g (25 mmol) HBVE was then added as a terminal-blocking agent and the reaction continued for 30 min. A vinyl-ether-functionalized polyurethane having a number average theoretical molecular weight Mₙ of 5000 g/mol was obtained.

### Example 3: Synthesis of Acetal-Containing Polymer

The polyurethane (VEPU) from Example 2 was dissolved in the same volume of acetone and formulated as specified in Table 1 using 2 wt. % Omnicat 440 as a photoinitiator, based on the pure polyurethane, and octanediol or undecanol. The solvent was then removed at reduced pressure (100 mbar).

TABLE 1
Formulations of VEPU with octanediol or undecanol

| | m | n (vinyl | m (alco- | n (OH | m |
|---|---|---|---|---|---|
| | (VEPU) | ether) | hol) | groups) | (photoinitiator) |
| | [g] | [mmol] | [g] | [mmol] | [g] |
| VEPU/octanediol | 3.00 | 9.49 | — | — | 0.06 |
| (1:0) | | | | | |
| VEPU/octanediol | 3.00 | 9.49 | 0.35 | 4.74 | 0.06 |
| (1:0.5) | | | | | |
| VEPU/octanediol | 3.00 | 9.49 | 0.69 | 9.49 | 0.06 |
| (1:1) | | | | | |
| VEPU/octanediol | 3.00 | 9.49 | 1.04 | 14.23 | 0.06 |
| (1:1.5) | | | | | |
| VEPU/undecanol | 3.00 | 9.49 | 0.82 | 4.74 | 0.06 |
| (1:0.5) | | | | | |

The addition of octanediol has a positive effect on curing behavior. The starting viscosity is reduced by approximately one order of magnitude and the molecular mobility increased significantly. As a result, higher conversion rates of vinyl ether groups can be achieved, which also explains the higher mechanical modulus following curing. Although it would be expected in theory that the incorporation of polyol segments would impair the mechanical properties since the newly formed acetal bridges are comparably flexible and should thus have a softening effect, this effect is more than offset by the higher conversion rate of vinyl ether groups. The presence of flexible bonds and the less rigid cross-linking is also demonstrated by the reduced glass transition temperature.

It was shown that the material can be readily removed from a glass/aluminum bond when it is soaked in an acidic solvent.

The cationic phototransfer polymerization was then carried out using a sample of VEPU and undecanol in the molar ratio of vinyl ether to hydroxyl of 1:0.5. A UV/NIR rheology was carried out at 25° C. again in order to obtain cured films having a defined geometry. As expected, the softening effect was much more pronounced compared with octanediol. Gelation is delayed under identical stoichiometry conditions and occurs at a vinyl ether conversion level of 23%. The resulting flexible yet sturdy films were mechanically detached from the rheometer structure and treated using small amounts of triethylamine in order to remove photoacid residues.

A solid phase 13C NMR spectroscopy was then carried out on the dried films using magic angle spinning (MAS) in order to demonstrate the formation of acetal bonds in the gelled polymer structures. By means of these methods, the formation of acetals in the polymer structures could be proven beyond doubt.

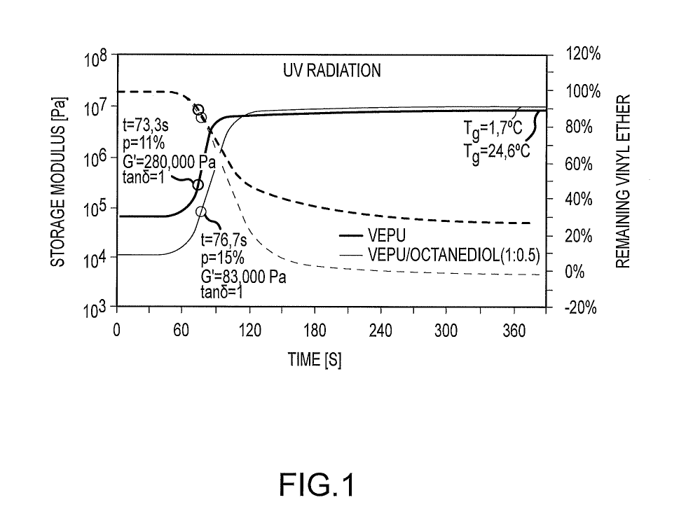

The cationic curing reaction of the polymer in the presence of octanediol was carried out in a UV/NIR rheology experiment. The mechanical storage modulus and the remaining vinyl ether content were recorded at the same time upon exposure to UV at 25° C. and plotted against time. The results are shown in FIG. 1. FIG. 1 shows the storage moduli (dashed lines) and the remaining vinyl ether content (solid lines) of the curing reaction of VEPU without octanediol and with octanediol in the molar ratio of vinyl ether groups to hydroxyl groups of 1:0.5 following brief exposure to UV at 25° C. The gelation point is shown by empty circles. The stated glass transition temperatures T_{g} after curing were determined by means of DSC.

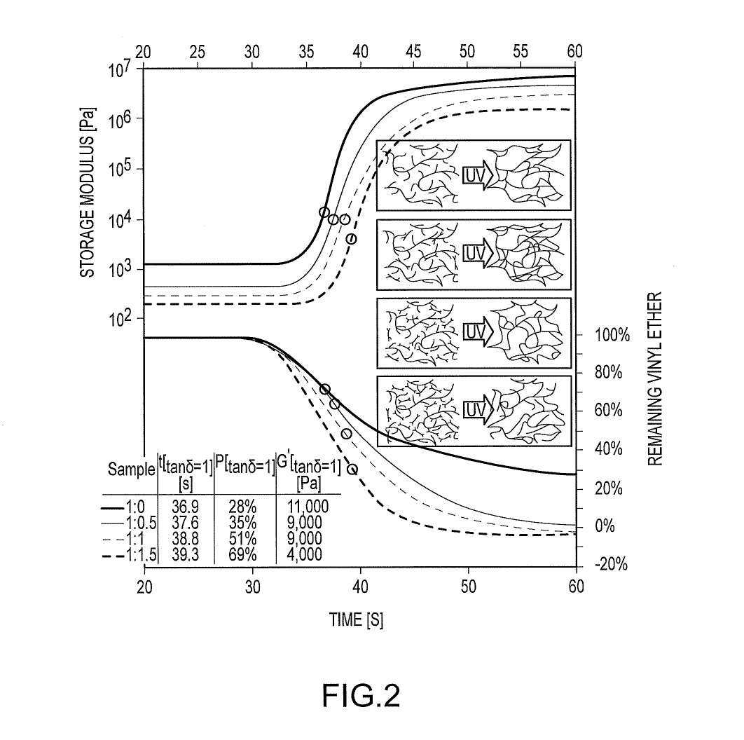

To better understand cationic phototransfer polymerization, additional samples were produced using varying stoichiometry and cured at a higher temperature (70° C.). The results are shown in FIG. 2. FIG. 2 shows the rheological plots of the curing reaction of VEPU and octanediol at 70° C. and altered stoichiometry. The gelation is again shown by empty circles. The increased temperature prevents glass formation in the samples and ensures the reaction proceeds unhindered. The expected trend of lower plateau values for the moduli having a higher octanediol content was observed. Conversion upon sample gelation increased with the octanediol content, clearly demonstrating the incorporation of the hydroxyl-functionalized components in the curing VEPU network.

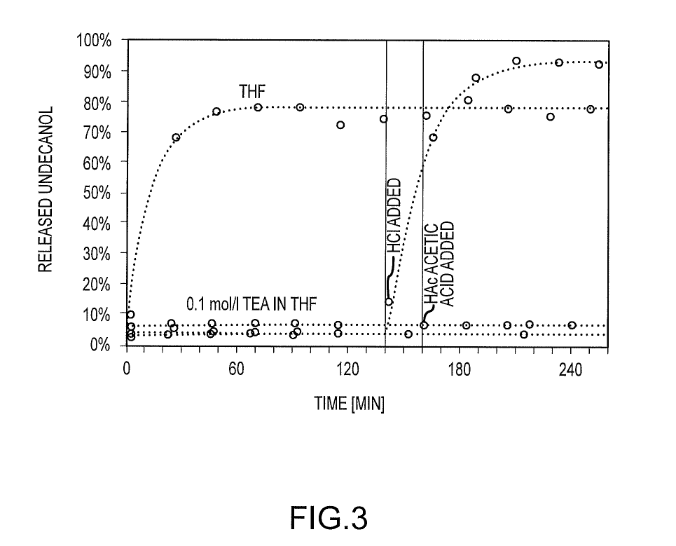

To examine the effectiveness and kinetics of the release more accurately, a gas chromatography analysis was carried out, using samples that had been treated for several hours under different pH conditions. FIG. 3 shows the relative undecanol that could be extracted from polymer films soaked in THF as a function of duration of exposure and various additional components. The black curve shows the increasing undecanol concentration in the moist THF supernatant (0.36 mol/L H₂O). The undecanol concentration increases within minutes to 78% of the amount added at the outset. This result can be explained by photoacid residues from the UV initiation, which is sufficient to cause hydrolysis of the acetal bonds when the film is soaked in hydrous solvents. Therefore, the other polymer films were soaked in alkaline THF, containing 0.1 mol/L triethylamine, in order to neutralize the remaining acid. Under these conditions, only 4-7% of the undecanol could be extracted, which presumably corresponds to the remaining unbonded undecanol from the reaction. After an extraction time of 139 minutes, hydrochloric acid was added to one of these samples, while another sample was treated with acetic acid after 158 minutes. In both cases, an acid concentration of 0.1 mol/L was set following neutralization. The weak acetic acid did not cause a higher content of free undecanol, whereas the hydrochloric acid caused the hydrolysis of the acetals and led to 94% of the added undecanol to be released after 80 minutes at room temperature.

1. A method for producing an acetal-containing polymer comprising:
providing at least one polymer that has alkenyl ether group side chains and contains, as a monomer unit, at least one alkenyl ether polyol containing at least one alkenyl ether group and at least two hydroxyl groups (—OH),
providing at least one monofunctional or polyfunctional alcohol, and
reacting the at least one polymer that has alkenyl ether group side chains and the at least one monofunctional or polyfunctional alcohol to provide the acetal-containing polymer.

2. The method according to claim 1 wherein the acetal-containing polymer is an acetal-containing polyurethane polymer or an acetal-containing polyester polymer.

3. The method according to claim 1 wherein the at least one alkenyl ether polyol contains at least one 1-alkenyl ether group.

4. The method according to claim 1 wherein the at least one polymer is a polyurethane polymer or a polyester polyol.

5. The method according to claim 1, wherein the alkenyl ether polyol is obtained by:
A) reacting an alkenyl ether, containing at least one alkenyl ether group and at least one functional group selected from —OH, —COOH, —SH, —NH₂, and the derivatives thereof, with (i) an epoxide or (ii) a cyclic carbonate or a derivative thereof; or
B) reacting an alkenyl ether, containing at least one alkenyl ether group and at least one functional group selected from (i) epoxide groups and (ii) cyclic carbonate groups or derivatives thereof, with an alcohol, thiol, a carboxylic acid, or an amine or derivatives thereof.

6. The method according to claim 5, the alkenyl ether polyol being obtained by reacting an alkenyl ether, containing at least one alkenyl ether group and at least one functional group selected from —OH, —COOH, —SH, —NH₂, and the derivatives thereof, with (i) an epoxide or (ii) a cyclic carbonate or a derivative thereof, wherein the alkenyl ether polyol is an alkenyl ether polyol of formula (I) 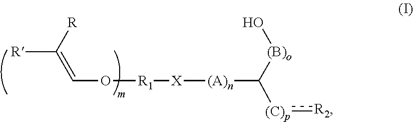
where
R₁ is an at least divalent organic group, or an at least divalent linear or branched, substituted or unsubstituted alkyl having from 1 to 20 carbon atoms, or a linear or branched, substituted or unsubstituted heteroalkyl having from 1 to 20 carbon atoms and at least one oxygen or nitrogen atom;
R₂ is an organic group, optionally comprising at least one —OH group and/or from 1 to 1000 carbon atoms, or an optionally divalent or polyvalent linear or branched, substituted or unsubstituted alkyl having from 1 to 20 carbon atoms, or a linear or branched, substituted or unsubstituted heteroalkyl having from 1 to 20 carbon atoms and at least one oxygen or nitrogen atom;
X is O, S, C(═O)O, OC(═O)O, C(═O)OC(═O)O, NRₓ, NRₓC(═O)O, NRₓC(═O)NRₓ or OC(═O)NRₓ;
each R and R′ is selected independently from H, C₁₋₂₀ alkyl, and C₂₋₂₀ alkenyl, or one of R and R′ is H and the other is C₁₋₄ alkyl, or both R and R′ are H;
each A, B, and C is independently selected from CR″R′″,
R″ and R′″ are selected independently from H, a functional group, an organic group, C₁₋₂₀ alkyl, or R″ and R′″ are an organic group either together or with the carbon atom to which they are bonded, or two of R″ and R′″ bonded to adjacent carbon atoms together form a bond in order to form a double bond between the adjacent carbon atoms, [symbol]
is a single or double bond, and, if it is a double bond, the carbon atom bonded to R₂ bears only one substituent R″ or R′″,
m is an integer from 1 to 10,
n, p, and o are each 0 or an integer from 1 to 10, where n p o=1 or more, and
Rₓ is H, an organic group, or 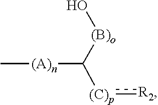
and, if Rₓ is not 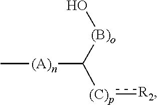
R₂ comprises at least one substituent selected from —OH and

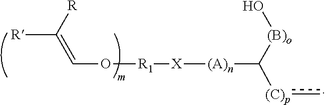

7. The method according to claim 5, the alkenyl ether polyol being obtained by reacting an alkenyl ether, containing at least one alkenyl ether group and at least one functional group selected from (i) epoxide groups and (ii) cyclic carbonate groups or derivatives thereof, with an alcohol, thiol, a carboxylic acid, or an amine or derivatives thereof, wherein the alkenyl ether polyol is an alkenyl ether polyol of formula (V) 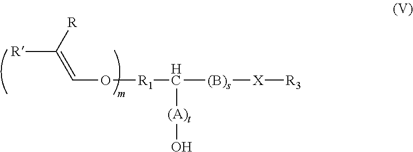
where
R₁ is an at least divalent organic group, or an at least divalent linear or branched, substituted or unsubstituted alkyl having from 1 to 20 carbon atoms, or a linear or branched, substituted or unsubstituted heteroalkyl having from 1 to 20 carbon atoms and at least one oxygen or nitrogen atom;
R₃ is an organic group, optionally comprising from 1 to 1000 carbon atoms, or an optionally divalent or polyvalent, linear or branched, substituted or unsubstituted alkyl having from 1 to 20 carbon atoms, or a linear or branched, substituted or unsubstituted heteroalkyl having from 1 to 20 carbon atoms and at least one oxygen or nitrogen atom, or a (poly)alkylene glycol of formula —O—[CHRₐCH₂O]_{b}—R_{b}, where Rₐ is H or a C₁₋₄ alkyl group, R_{b} is H or 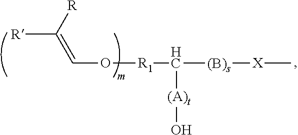
and b is from 1 to 100;
X is O, S, OC(═O), OC(═O)O, OC(═O)OC(═O), NR_{z}, NR_{z}C(═O)O, NR_{z}C(═O)NR_{z} or OC(═O)NR_{z};
each R and R′ is selected independently from H, C₁₋₂₀ alkyl, and C₂₋₂₀ alkenyl, or one of R and R′ is H and the other is C₁₋₄ alkyl, or both R and R′ being H;
each A and B is independently selected from CR″R′″,
R″ and R′″ are selected independently from H, a functional group, an organic group, C₁₋₂₀ alkyl, or R″ and R′″ are an organic group either together or with the carbon atom to which they are bonded, or two of R″ and R′″ bonded to adjacent carbon atoms together form a bond in order to form a double bond between the adjacent carbon atoms,
m is an integer from 1 to 10,
s and t are each 0 or an integer from 1 to 10, where s+t=1 or more, and
R_{z} is H, an organic group, or 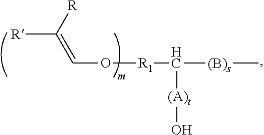
and, if R_{z} is not 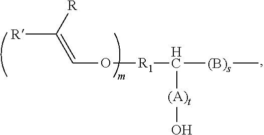
R₃ comprises at least one substituent that is selected from —OH and

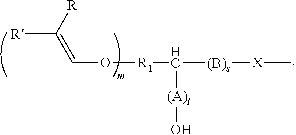

8. The method according to claim 1, wherein the monofunctional or polyfunctional alcohol is a compound of formula (VI)
R₄(OH)ᵤ (VI)
where
R₄ is a monovalent or polyvalent organic group, or a monovalent or divalent linear or branched, substituted or unsubstituted alkyl having from 1 to 20 carbon atoms, or a linear or branched, substituted or unsubstituted heteroalkyl having from 1 to 20 carbon atoms and at least one oxygen or nitrogen atom; and
u is an integer from 1 to 10, preferably from 1 to 4.

9. The method according to claim 1, wherein the monofunctional or polyfunctional alcohol is a hydroxyl group-containing polymer, having a functionality of from 1 to 1000.

10. The method according to claim 1, wherein the molar ratio of alkenyl ether groups to hydroxyl groups is in the range of from 0.1 to 10.

11. An acetal-containing polymer or cross-linked compound obtained from the method according to claim 1.

12. A method for the pH-based degradation of a polymer, comprising:
providing the acetal-containing polymer or cross-linked compound according to claim 11;
providing an aqueous solution having a pH of <7; and
contacting the polymer or cross-linked compound with the aqueous solution having a pH of <7; and
degrading the polymer.

13. A method for the pH-based release of a hydroxyl group-containing compound from a polymer, comprising:
providing the acetal-containing polymer according to claim 11;
providing an aqueous solution having a pH of <7; and
contacting the polymer with the aqueous solution having a pH of <7;
releasing the hydroxyl group-containing compound from the polymer.

14. A composition comprising at least one acetal-containing polymer according to claim 11.

15. Cured reaction products of the composition according to claim 14.
